(19) United States
(12) Patent Application Publication
(10) Pub. No.: US 2021/0239851 A1
(43) Pub. Date: Aug. 5, 2021

(54) POSITION DETERMINATION METHOD AND DEVICE BASED ON POSE DATA

(71) Applicant: SZ DJI TECHNOLOGY CO., LTD., Shenzhen (CN)

(72) Inventors: Yang GAO, Shenzhen (CN); Minghui LI, Shenzhen (CN)

(21) Appl. No.: 17/234,784

(22) Filed: Apr. 19, 2021

Related U.S. Application Data
(63) Continuation of application No. PCT/CN2018/122437, filed on Dec. 20, 2018.

(51) Int. Cl. G01S 19/43; G01S 19/04; G01S 19/23; G01S 19/07

(52) U.S. Cl. CPC G01S 19/43; G01S 19/04; G01S 19/47; G01S 19/071; G01S 19/23

(57) ABSTRACT

A device includes a Global Navigation Satellite System (GNSS) receiver configured to receive GNSS signals from one or more navigational satellites; a pose sensor configured to measure pose data of the GNSS receiver; and one or more processors configured to provide correction data based on the GNSS signals and the pose data.

### CROSS-REFERENCE TO RELATED APPLICATION

This application is a continuation of International Application No. PCT/CN2018/122437, filed Dec. 20, 2018, the entire content of which is incorporated herein by reference.

### TECHNICAL FIELD

The present disclosure relates to positioning technologies and, more particularly, to a position determination method and device based on pose data.

### BACKGROUND

In conventional technology, when a communication base station (e.g., a base station used for searching satellites and transmitting positioning data) is being set up, the base station is installed and fixed by mechanical structure at a predetermined location. The base station is then considered to always be a fixed and still status. Location offset, such as tilting or movement, caused by uncontrollable environmental factors cannot be discovered and corrected in time. Further, interaction with users, such as informing the reliability of data provided by the base station and whether the base station is operating correctly in real time, does not exist. The reliability of the base station may decrease as time goes by. If the tilt angle is too large or the base station collapses, the response time required for maintenance is long and can affect user experience.

Usually, maintenance of outdoor stationary equipment such as the base station relies on human operation. Service staff may go to the site periodically for investigation, visually check the working status of the base station, and roughly evaluate the reliability of the current base station. Such evaluation is qualitative but not quantitative, and cannot ensure accuracy and validity. Problems of the base station may also be derived from user feedback. However, accuracy and timeliness of maintenance operations cannot be guaranteed.

There is a need for developing a device (e.g., a device for providing positioning data) or system that can automatically determine pose data of the device and support user interaction, thereby providing data with higher reliability and accuracy.

### SUMMARY

In accordance with the present disclosure, there is provided a device. The device includes a Global Navigation Satellite System (GNSS) receiver configured to receive GNSS signals from one or more navigational satellites; a pose sensor configured to measure pose data of the GNSS receiver; and one or more processors configured to provide correction data based on the GNSS signals and the pose data.

Also in accordance with the present disclosure, there is provided a device. The device includes: a Global Navigation Satellite System (GNSS) receiver configured to receive GNSS signals from one or more navigational satellites; a pose sensor configured to provide sensing data related to a pose of the GNSS receiver; one or more processors configured to: calculate positioning data of the device based on at least in part of the GNSS signals; and determine pose data of the GNSS receiver based on the sensing data provided by the pose sensor; and a communication circuit configured to transmit both the positioning data and the pose data.

Also in accordance with the present disclosure, there is provided a device. The device includes: a Global Navigation Satellite System (GNSS) receiver configured to receive GNSS signals from one or more navigational satellites; a pose sensor configured to measure pose data of the GNSS receiver relative to a target position; and one or more processors configured to determine positioning data of the target position based on the GNSS signals and the pose data.

Also in accordance with the present disclosure, there is provided a device. The device includes: a Global Navigation Satellite System (GNSS) receiver configured to receive GNSS signals from one or more navigational satellites; a communication circuit configured to receive correction data from a GNSS base station, the correction data being generated based on pose data associated with the GNSS base station; and one or more processors configured to determine positioning data associated with the device based on the correction data and the GNSS signals.

Also in accordance with the present disclosure, there is provided a device. The device includes: a Global Navigation Satellite System (GNSS) receiver configured to receive GNSS signals from one or more navigational satellites; a communication unit configured to receive correction data and pose data from a GNSS base station; and one or more processors configured to: modify the correction data using the pose data; and determine positioning data associated with the device based on the modified correction data and the GNSS signals.

Also in accordance with the present disclosure, there is provided a device. The device includes: a Global Navigation Satellite System (GNSS) receiver configured to receive GNSS signals from one or more navigational satellites; a communication unit configured to receive correction data and pose data from a GNSS base station; and one or more processors configured to determine whether to use the correction data to determine positioning data associated with the device based at least in part on the pose data and based on the GNSS signals.

Also in accordance with the present disclosure, there is provided a device. The device includes: a Global Navigation Satellite System (GNSS) receiver configured to receive GNSS signals from one or more navigational satellites; a communication unit configured to receive, from each of a plurality of GNSS base stations, correction data and pose data; and one or more processors configured to: select one or more GNSS base stations from the plurality of GNSS base stations based at least in part on the pose data associated with the one or more GNSS base stations; and determine positioning data associated with the device based at least in part on the GNSS signals and the correction data associated with the one or more selected GNSS base stations.

Also in accordance with the present disclosure, there is provided a server. The server includes: a communication circuit configured to receive positioning data and pose data from a GNSS base station; and one or more processors configured to determine whether to provide the positioning data to a remote device based at least in part on the pose data.

Also in accordance with the present disclosure, there is provided a server. The server includes: a communication circuit configured to receive positioning data and pose data from each of a plurality of GNSS base stations; and one or more processors configured to: select one or more GNSS base stations from the plurality of GNSS base stations based at least in part on the pose data associated with the one or more GNSS base stations; and determine positioning data of a target position based at least in part on the GNSS signals and the positioning data associated with the one or more selected GNSS base stations.

Also in accordance with the present disclosure, there is provided a controller. The controller includes: one or more processors configured to obtain pose data of one or more GNSS receivers and perform an operation according to the pose data, the one or more GNSS receivers including at least one of a GNSS base station or a GNSS mapping device; and a communication circuit configured to receive correction data from the GNSS base station, and send the correction data of the GNSS base station to the GNSS mapping device.

Also in accordance with the present disclosure, there is provided a device. The device includes: a display configured to present a graphical user interface; and one or more processors configured to obtain positioning data and pose data of a GNSS receiver; and present, on the graphical user interface, information based at least in part on the positioning data and the pose data.

Also in accordance with the present disclosure, there is provided a method executed by a GNSS base station. The method includes receiving one or more Global Navigation Satellite System (GNSS) signals by the GNSS base station; determining, by the GNSS base station, pose data of the GNSS base station; and providing, by the GNSS base station, correction data based on the GNSS signals and the pose data.

Also in accordance with the present disclosure, there is provided a method executed by a GNSS base station. The method includes: receiving one or more Global Navigation Satellite System (GNSS) signals by the GNSS base station; calculating positioning data of the GNSS base station based on at least in part of the GNSS signals; determining, by the GNSS base station, pose data of the GNSS base station; and transmitting both the positioning data and the pose data.

Also in accordance with the present disclosure, there is provided a method executed by a mapping device. The method includes: receiving, by a GNSS receiver of the mapping device, GNSS signals from one or more navigational satellites; measuring, by the mapping device, pose data of the GNSS receiver relative to a target position; and determining, by the mapping device, positioning data of the target position based on the GNSS signals and the pose data.

Also in accordance with the present disclosure, there is provided a method. The method includes: receiving, by a device, GNSS signals from one or more navigational satellites; receiving, by the device, correction data from a GNSS base station, the correction data being generated based on pose data associated with the GNSS base station; and determining, by the device, positioning data associated with the device based on the correction data and the GNSS signals.

Also in accordance with the present disclosure, there is provided a method. The method includes: receiving, by a device, GNSS signals from one or more navigational satellites; receiving, by the device, correction data and pose data from a GNSS base station; modifying the correction data using the pose data; and determining positioning data associated with the device based on the modified correction data and the GNSS signals.

Also in accordance with the present disclosure, there is provided a method. The method includes: receiving, by a device, GNSS signals from one or more navigational satellites; receiving, by the device, correction data and pose data from a GNSS base station; and determining whether to use the correction data to determine positioning data associated with the device based at least in part on the pose data and based on the GNSS signals.

Also in accordance with the present disclosure, there is provided a method. The method includes: receiving, by a device, GNSS signals from one or more navigational satellites; receiving, by the device, from each of a plurality of GNSS base stations, correction data and pose data; selecting one or more GNSS base stations from the plurality of GNSS base stations based at least in part on the pose data associated with the one or more GNSS base stations; and determining positioning data associated with the device based at least in part on the GNSS signals and the correction data associated with the one or more selected GNSS base stations.

Also in accordance with the present disclosure, there is provided a method. The method includes: receiving, by a server, positioning data and pose data from a GNSS base station; and determining, by the server, whether to provide the positioning data to a remote device based at least in part on the pose data.

Also in accordance with the present disclosure, there is provided a method. The method includes: receiving, by a server, positioning data and pose data from each of a plurality of GNSS base stations; selecting, by the server, one or more GNSS base stations from the plurality of GNSS base stations based at least in part on the pose data associated with the one or more GNSS base stations; and determining, by the server, positioning data of a target position based at least in part on the GNSS signals and the positioning data associated with the one or more selected GNSS base stations.

Also in accordance with the present disclosure, there is provided a method. The method includes: obtaining, by a controller, pose data of one or more GNSS receivers and perform an operation according to the pose data, the one or more GNSS receivers including at least one of a GNSS base station or a GNSS mapping device; receiving, by the controller, correction data from the GNSS base station, and sending the correction data of the GNSS base station to the GNSS mapping device.

Also in accordance with the present disclosure, there is provided a method. The method obtaining, by a device positioning data and pose data of a GNSS receiver; and presenting, on a graphical user interface of the device, information based at least in part on the positioning data and the pose data.

### BRIEF DESCRIPTION OF THE DRAWINGS

FIG. 1 is a schematic diagram showing an operating environment according to exemplary embodiments of the present disclosure;

FIG. 2A is a schematic view of a GNSS receiver according to an exemplary embodiment of the present disclosure;

FIG. 2B is a schematic view of the GNSS receiver shown in FIG. 2A in a tilted status;

FIG. 3 is a schematic block diagram of a terminal according to exemplary embodiments of the present disclosure;

FIG. 4A is a schematic block diagram of a device according to exemplary embodiments of the present disclosure.

FIG. 4B is a schematic view of a tilted GNSS receiver according to an exemplary embodiment of the present disclosure;

FIG. 5 is a flow chart of a process according to an exemplary embodiment of the present disclosure;

FIG. 6 is a schematic view showing an application scenario according to an exemplary embodiment of the present disclosure;

FIG. 7 is a flow chart of a positioning process according to the application scenario shown in FIG. 6;

FIG. 8 is a schematic view showing another application scenario according to an exemplary embodiment of the present disclosure;

FIG. 9 is a flow chart of a positioning process according to the application scenario shown in FIG. 8;

FIG. 10 is a schematic view showing another application scenario according to an exemplary embodiment of the present disclosure; and

FIG. 11 is a flow chart of a positioning process according to the application scenario shown in FIG. 10; and

FIGS. 12A-12F are each a flow chart of a process according to an exemplary embodiment of the present disclosure.

### DESCRIPTION OF THE EMBODIMENTS

Hereinafter, embodiments consistent with the disclosure will be described with reference to the drawings, which are merely examples for illustrative purposes and are not intended to limit the scope of the disclosure. Wherever possible, the same reference numbers will be used throughout the drawings to refer to the same or like parts. In some example embodiments described below, Global Navigation Satellite System (GNSS) receiver and associated example methods are described. The GNSS receiver is merely an example of devices consistent with the disclosure, but is not intended to limit the devices consistent with the disclosure. A device consistent with the disclosure can be another type of device, such as another type of positioning device.

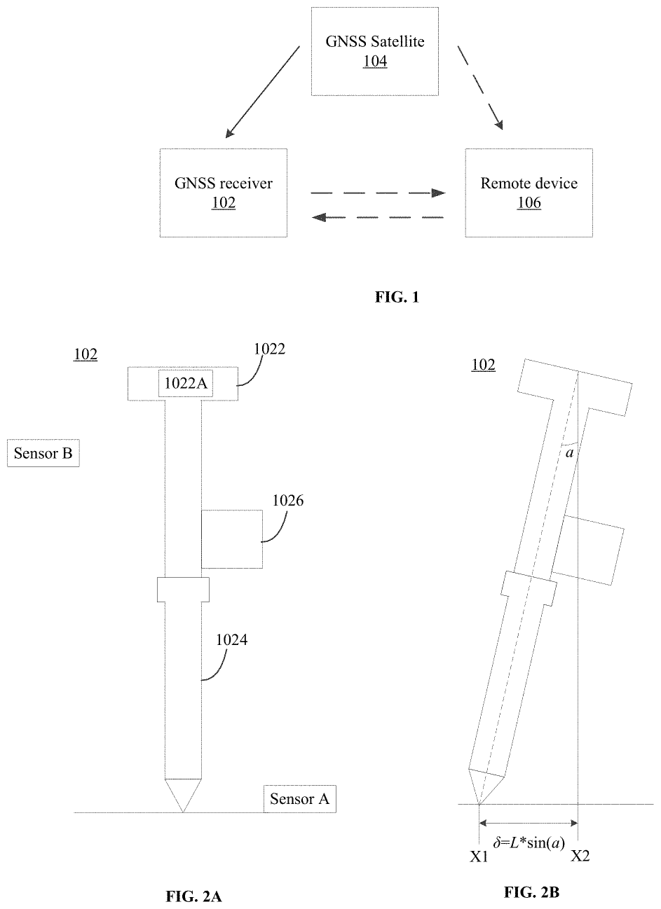

FIG. 1 is a schematic block diagram showing an operating environment according to exemplary embodiments of the present disclosure. As shown in FIG. 1, a Global Navigation Satellite System (GNSS) receiver 102 may receive and process signals from one or more navigational satellites 104 and generate positioning data based on the received signals. The GNSS receiver 102 may connect with a remote device 106 and provide the generated positioning data to the remote device 106. The positioning data may be used in various positioning and navigation applications such as automatic driving, surveying, and mapping, etc.

In some embodiments, the GNSS receiver 102 may be a dual-frequency receiver for high-precision positioning. The GNSS receiver 102 may determine its position (e.g. coordinates of a location at which the GNSS receiver 102 stands) based on signals received from navigational satellite. Such a position determined based on signals from navigational satellites is also referred to as a “satellite position” or a “measures position.” The GNSS receiver 102 may function as a base station or a rover in a positioning system.

A base station, as used herein, may refer to a GNSS receiver located at a fixed position. In operation, the base station may preset a reference position as a known position of the base station itself. The reference position may represent a true position based on previously surveyed and leveled data. The satellite position generated by the same base station may be slightly different from the reference position due to different conditions of environmental atmosphere (e.g., cloud, rain, solar weather) or inherent systemic/hardware error. Correction data, such as GNSS differential positioning data, as used herein, may refer to data describing the difference between the reference position and the satellite position. The GNSS differential positioning data may be transmitted in a format compatible with Radio Technical Commission for Maritime Services (RTCM) standard. The base station is a source that produces the correction data and may transmit the correction data to a rover (also referred to as a “mapping device”) in the positioning system. The correction data may be used by the rover to correct positioning information. In one embodiment, the base station may be a mobile base station that is fixed during a mapping/surveying session and can be put away when the session ends. The session may last less than an hour, a couple of hours, or a couple of days. In another embodiment, the base station may be a stationary base station that remains at a fixed position for a longer time, such as a couple of years, and hence can be considered to be more “permanent” than a mobile base station.

A rover or a mapping device in the positioning system, as used herein, may refer to a GNSS receiver that moves in a field and maps positions of one or more location points in the field. The rover may obtain the satellite position of itself while being placed at a target location, correct the satellite position using the correction data provided by the base station to produce and record positioning information of the target location with higher accuracy. The rover may move on to a next target location point and map positioning information of the next location point. The rover may be any movable device that receives GNSS signal, such as a handheld mapping device, an unmanned vehicle (UV) or an unmanned aerial vehicle (UAV). The rover may stay within a coverage range of the base station, and in the coverage range of the base station, the environment of the rover such as atmosphere conditions are the same or similar as that of the base station, so that the accuracy of the positioning information generated by the rover is ensured. In some embodiments, the closer the rover is to the base station, the more accurate the positioning information of the location point is. In some embodiments, the rover may receive the differential positioning data of multiple base stations, and interpolate multiple differential positioning data to produce the positioning information with higher accuracy. In some embodiments, the positioning system may include one base station and multiple rovers for producing corrected position information of location points. In some embodiments, the rover may receive the differential positioning data directly sent by the base station, forwarded by a controller, and/or sent by a positioning service server.

The remote device 106 may be a rover, a controller, a base station, and/or a server. In some embodiments, one of the GNSS receiver 102 and the remote device 106 may be a base station and the other one may be a rover. In some embodiments, the remote device may be a controller wirelessly connected with the GNSS receiver 102 and receives data from the GNSS receiver 102. The controller may be a remote control of a UAV/UV, a mobile phone, a tablet, a laptop, etc. An application program (App) may be installed and executed on the controller. When running the App, the controller may display a graphical interface that presents the data produced by the GNSS receiver 102 and/or the remote device 106. In some embodiments, the remote device 106 may be a positioning service server, such as a Continuously Operating Reference Station (CORS) server. The CORS server may be connected to a network of base stations (e.g., multiple GNSS receiver 102), receive differential positioning data from the base stations at known locations, and provide positioning and/or navigation services based on the differential positioning data.

In some embodiments, the GNSS receiver 102 may support real-time kinematic (RTK) positioning and provide the positioning data with at least centimeter-level accuracy. RTK positioning uses measurements of the phase of the GNSS signal's carrier wave (e.g., for obtaining satellite position) and relies on a single reference station or interpolated virtual stations to provide real-time corrections (e.g., differential positioning data). In high-precision positioning applications, a slight tilt or movement of the GNSS receiver 102 may affect the accuracy of the positioning data generated by the GNSS receiver 102.

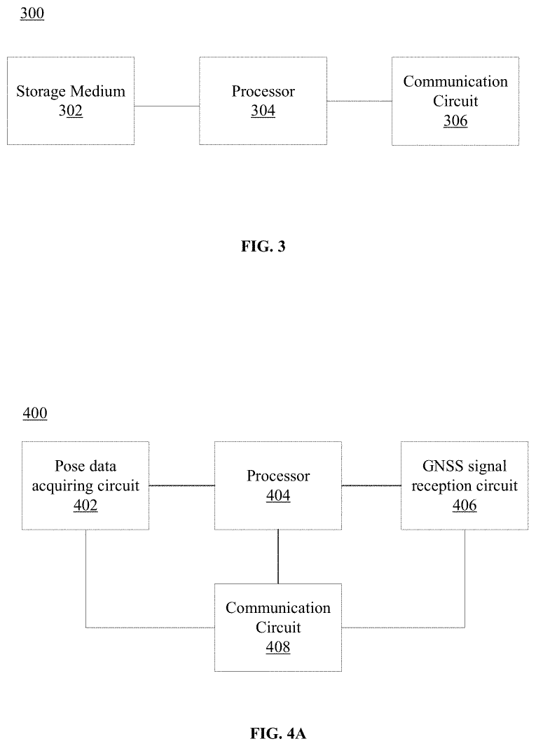

FIG. 2A is a schematic view of a GNSS receiver 102 according to an exemplary embodiment of the present disclosure. As shown in FIG. 2A, the GNSS receiver 102 includes a main body 1022 and a mounting base 1024. Antennas for receiving GNSS signals (e.g., GNSS signal reception circuit) may be installed at a top section of the main body 1022, e.g., at 1022A. In one embodiment, one or more sensors (e.g., IMU) for providing pose data of the GNSS receiver may be co-located with the GNSS signal reception circuit, e.g., at 1022A. In another embodiment, the one or more sensors may be located at any suitable place on the GNSS receiver (e.g., main body 1022, attachment 1026). The sensing data collected by the one or more sensors may be modified based on the displacement between the GNSS antennas and the sensor such that the modified sensing data reflects the pose of the GNSS signal reception circuit. In another embodiment, the one or more sensors may not be local sensors embedded in the GNSS receiver 102, and may be located at any suitable locations near the GNSS receiver 102. For example, Sensor A and/or Sensor B as shown in FIG. 2A may be a vision sensor and/or a distance sensor. Such sensor may be fixated at a preset distance from the GNSS receiver 102 to monitor the pose of the GNSS receiver or may be carried by a movable object and record the pose of the GNSS receiver when the movable object is passing by. The main body 1022 may be mounted on the mounting base 1024. The mounting base 1024 may include any proper structure that supports a handheld application and/or a fixed station application. In one example, the mounting base 1024 may include a tripod or a structure compatible with a tripod so that the main body 1022 can be in an upright and stable status when receiving GNSS signals and producing positioning data. In another example, the mounting base 1024 may be a rod or bar suitable for handheld applications. In some embodiments, as shown in FIG. 2A, the GNSS receiver 102 further includes an attachment 1026 attached to the main body 1022. The attachment 1026 may include a compartment and/or a holder for battery, communication dongle, a controller, and/or other applicable hardware.

FIG. 2B is a schematic view of the GNSS receiver 102 shown in FIG. 2A in a tilted status. The GNSS receiver 102 may intend to record the coordinates of location X1 where the bottom tip stands. When the GNSS receiver 102 is tilted, since the antenna is located at the top, the GNSS receiver may actually record the coordinates of location X2. That is, an error δ is produced and can be calculated as δ=L*sin(a), where a is the tilt angle and L is the length of the GNSS receiver 102. Assuming the length L is 150 centimeters and the tilt angle is 10 degrees, the error is about 26 centimeters. Currently, latitude and longitude convergence accuracy of a GNSS receiver that supports RTK positioning is no greater than 5 centimeters. Thus, the error caused by the tilt is not negligible in the positioning data produced with centimeter-level accuracy. Further, if the GNSS receiver 102 is moved from the original location by a centimeter-level distance, or if the GNSS receiver 102 is swaying and causing the antenna to be not aligned with the bottom, the error in the positioning data generated by the GNSS receiver 102 under these circumstances are also not negligible. When the positioning data is used in producing a high-precision map, such error can affect the correctness of the map. When the positioning data is used for automatic driving, such error can cause the vehicle to deviate from a lane.

The present disclosure provides a device with high reliability and accuracy by using automatically generated pose data of the device. When the pose data of the device indicates that the device is tilted or moved, the device can perform an operation corresponding to this situation, such as preventing the data generated by the device while the device is tilted or moved to be used, prompting a warning message to a user, and/or correct the generated data based on a tilted degree or moved distance. As indicated above, GNSS receiver is an example device of the present disclosure. The present disclosure may be applied to any device providing data that might have an impaired accuracy due to a change in spatial status of the device.

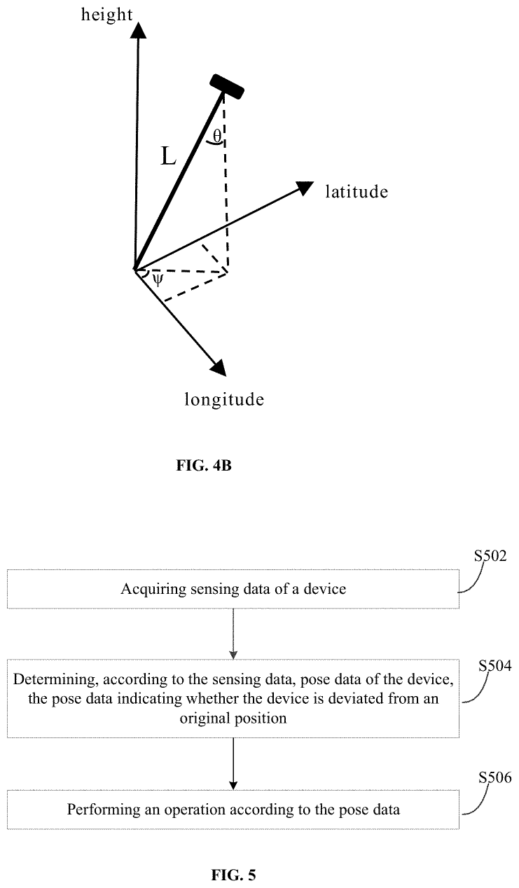

FIG. 3 is a schematic block diagram of a terminal 300 according to exemplary embodiments of the present disclosure, such as a computing terminal. The terminal 300 may be implemented in any suitable entity consistent with the disclosure, such as the GNSS receiver 102 or the remote device 106. The terminal 300 may also be implemented in a base station, a rover, a controller, and/or a server. As shown in FIG. 3, the terminal 300 includes at least one storage medium 302, and at least one processor 304. According to the disclosure, the at least one storage medium 302 and the at least one processor 304 can be separate devices, or any two or more of them can be integrated in one device.

The at least one storage medium 302 can include a non-transitory computer-readable storage medium, such as a random-access memory (RAM), a read only memory, a flash memory, a volatile memory, a hard disk storage, or an optical medium. The at least one storage medium 302 coupled to the at least one processor 304 may be configured to store instructions and/or data. For example, the at least one storage medium 302 may be configured to store positioning data, configuration settings under various operation modes, computer executable instructions for implementing RTK positioning process, for determining spatial status (pose data) based on sensing data, for performing an operation corresponding to the spatial status, and/or the like.

The at least one processor 304 can include any suitable hardware processor, such as a microprocessor, a micro-controller, a central processing unit (CPU), a network processor (NP), a digital signal processor (DSP), an application specific integrated circuit (ASIC), a field-programmable gate array (FPGA), or another programmable logic device, discrete gate or transistor logic device, discrete hardware component. The at least one storage medium 302 stores computer program codes that, when executed by the at least one processor 304, control the at least one processor 304 to perform a method of using pose data to provide data with reliability and accuracy consistent with the disclosure, such as one of the exemplary methods described below. In some embodiments, the computer program codes also control the at least one processor 304 to perform some or all of the functions that can be performed by previously described base station, rover, controller, and server, each of which can be an example of the terminal 300.

In some embodiments, the terminal 300 may include other I/O (input/output) devices, such as a display, a control panel, a speaker, etc. The display may be configured to display a graphical user interface that presents positioning data or a warning message that a device is tilted. In some embodiments, the terminal 300 may also include a communication circuit 306. The communication circuit 306 may be configured to establish communication and perform data transmission with another device (e.g., a GNSS receiver or a server). The communication circuit 306 may include any number of transmitters and/or receivers and/or transceivers suitable for wired and/or wireless communication. The communication circuit 306 may include one or more antennas for wireless communication at any supported frequency channel. The communication circuit 306 may be configured to transmit incoming data (e.g., positioning data, pose data) received from an entity (e.g., another terminal 300) to the processor 304, and send outgoing data (e.g., positioning data, pose data) from the processor 304 to the entity. The communication circuit 306 may support any suitable communication protocol for communicating with the entity, such as a software-defined radio (SDR) communication protocol, a Wi-Fi communication protocol, a Bluetooth communication protocol, a Zigbee communication protocol, a WiMAX communication protocol, an LTE communication protocol, a GPRS communication protocol, a CDMA communication protocol, a GSM communication protocol, or a coded orthogonal frequency-division multiplexing (COFDM) communication protocol, etc.

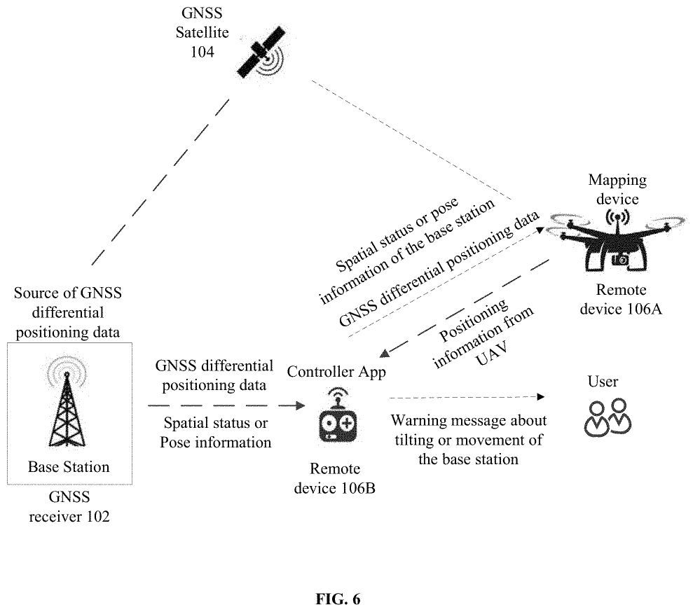

FIG. 4A is a schematic block diagram of a device according to exemplary embodiments of the present disclosure. As shown in FIG. 4A, the device 400 includes a pose data acquiring circuit 402 and at least one processor 404. The pose data acquiring circuit 402 may be configured to acquire sensing data or pose data of the device. The at least one processor 404 may be configured to determine, according to the sensing data, pose data of the device, and the pose data includes spatial status indicating whether the device is deviated from an original position; and perform an operation according to the spatial status. The at least one processor 404 may function in a similar manner as the at least on processor 304 shown in FIG. 3. In some embodiments, as shown in FIG. 4A, the device 400 further includes a communication circuit 408. The communication circuit 408 may function in a similar manner as the communication circuit 306 shown in FIG. 3.

In some embodiments, the pose data acquiring circuit 402 may include one or more local or non-local pose sensors that may sense the spatial status and/or collect pose data of the device 400. Examples of the sensors may include accelerometer, gyroscope, magnetometer, electromagnetic sensor, etc. Any suitable number and/or combination of sensors can be included. The pose data acquiring circuit 402 may include an inertial measurement unit (IMU) that combines accelerometer, gyroscope, and/or magnetometer. The IMU may detect acceleration and/or rotational rate in three axes: pitch, roll, and yaw, which may be included in the pose information. Sensing data collected by any other suitable sensors may be included in the pose data of the device. The spatial status of the device can be determined based on the pose data. The spatial status may include one or more of a value indicating whether the device is deviated from the original position (e.g., a binary value or a flag), a value indicating whether the device is tilted, a value indicating whether the device is moved, a value indicating whether the device is in a static state, etc. The spatial status may further include details describing the deviation from the original position, such as a tilt angle, a displacement, and/or an acceleration. In one embodiment, the device 400 may determine the spatial status based on the sensing data locally (e.g., by using: the IMU, the at least one processor 404, and one or more of the at least one processor 404 embedded in or coupled with the IMU). In another embodiment, the device 400 may send the sensing data to a remote device and receive the spatial status determined by the remote device based on the sensing data (e.g., through the communication circuit 408). In some embodiments, the pose data acquiring circuit 402 may include an optical measurement unit that combines optical transmitter and optical receiver. The pose data acquiring circuit 402 may detect the pose data by transmitting and receiving of light. In some embodiments, the pose data acquiring circuit 402 may also be configured to receive pose data or sensing data through the communication circuit 408.

In some embodiments, as shown in FIG. 4A, the device 400 further includes a GNSS signal reception circuit 406 configured to receive a signal from at least one Global Navigation Satellite System. The Global Navigation Satellite System may include Global Positioning System (GPS), Russia's Global Navigation Satellite System (GLONASS), Galileo global satellite-based navigation system, and/or BeiDou Navigation Satellite System (BDS). The GNSS signal reception circuit 406 may include any suitable number or type of antenna for receiving signals from one or more satellites in a navigational satellite constellation. The GNSS signal reception circuit 406 be configured to determine a satellite position based on the received GNSS signal and send the satellite position to the at least one processor 406. The GNSS signal reception circuit 406 may be configured to support dual-frequency signal reception and/or real-time positioning kinematic (RTK) positioning.

In some embodiments, the device 400 may be a GNSS receiver, such as the GNSS receiver 102 shown in FIGS. 1, 2A, and 2B. The GNSS signal reception circuit 406 may be installed on the main body 1022 (e.g., at a top portion or any other suitable locations). The sensors of the pose data acquiring circuit 402 may be installed at the same portion of the main body 1022. The pose data of the device may be the pose data of the GNSS signal reception circuit 402. The at least one processor 404 and the communication circuit 408 may be placed at any suitable part of the main body 1022 or the attachment 1026. For example, the communication circuit 408 may include a USB communication dongle inserted to a compatible socket of the attachment 1026.

FIG. 4B is a schematic view of a tilted GNSS receiver according to an exemplary embodiment of the present disclosure. In some embodiments, the output of the pose data acquiring circuit 402 may be further used in modifying positioning data generated based on the GNSS signals received by the GNSS signal reception circuit 406, so as to compensate an angle displacement from a predetermined pose (e.g., an upright pose). The positioning data may be a location represented by longitude, latitude, and height, which are respectively denoted as GNSS_{Longitude}, GNSS_{Latitude}, and GNSS_{Height}. The location may be a reference location or a measured location when the GNSS receiver operates at base station mode, or a measured location when the GNSS receiver operates at mapping device mode. The compensation of the angle displacement can be calculated by the following equation to obtain a modified location:

AD_{Longitude}=GNSS_{Longitude}+L sin θ cos φ

AD_{Latitude}=GNSS_{Latitude}+L sin θ cos φ

AD_{Height}=GNSS_{Height}+L(1+cos θ)

AD_{Longitude} is the adjusted longitude of the modified location, AD_{Latitude} is the adjusted latitude of the modified location, and AD_{Height} is the adjusted height of the modified location. θ is the tilted angle from the horizontal plane. φ is the angle from the direction of the equator. L is the of length of GNSS receiver.

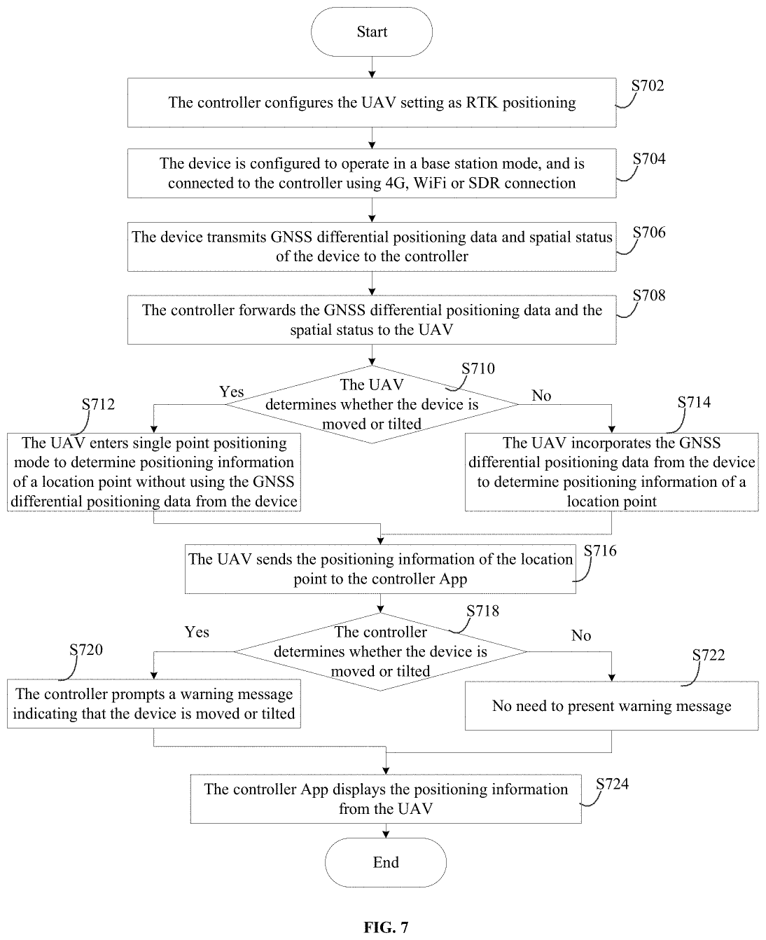

FIG. 5 is a flow chart of a process according to an exemplary embodiment of the present disclosure. The process may be implemented by any suitable apparatus or system, such as the GNSS receiver 102, the remote device 106, the terminal 300, the device 400 (e.g., the at least one processor 404), or a combination thereof. As shown in FIG. 5, at S502, sensing data of a device (e.g., device 400) is acquired. In some embodiments, the sensing data of the device may be measured from an inertial measurement unit (IMU) coupled to the device.

At S504, pose data of the device is determined according to the sensing data. The pose data may also be referred as spatial status. The spatial status indicates whether the device is deviated from an original position. The original position, as used herein, may refer to a predetermined pose or a known pose of the device. For example, for a base station, the predetermined pose may be a fixed location and a fixed posture (e.g., standing upright at the reference position); and for a rover, the predetermined pose may be a predetermined posture (e.g., being held upright). The spatial status may include, for example, a tilt status, a displacement status, and/or an acceleration status of the device. The spatial status may further include details describing the deviation from the original position, such as a tilt angle, a displacement, and/or an acceleration. The tilt status may include whether a tilt angle between a current reference axis of the device and a predetermined reference axis (e.g., vertical axis perpendicular to the earth surface) of the device is greater than an angle threshold. The tilt angle or the tilt status may indicate both a tilted amplitude and a tilted direction. When the tilt angle (the amplitude of the tilt angle) is greater than the angle threshold, it may be determined that the device is deviated from the original position. The displacement status may include whether a displacement between a current location of the device and a predetermined location of the device is greater than a distance threshold. The displacement or the displacement status may include both the distance and direction of the movement. When the displacement (moved distance) is greater than the distance threshold, it may be determined that the device is deviated from the original position. The acceleration status may include whether an acceleration of the device within a time period is greater than an acceleration threshold. When the acceleration is greater than the acceleration threshold, it may be determined that the device is deviated from the original position. In some embodiments, the spatial status may be determined by the device. In some embodiments, the above mentioned thresholds may be preset locally in the device. In some embodiments, the above mentioned thresholds may be determined by another entity in the same system as the device and connected to the device, such as a server and/or a controller.

At S506, an operation is performed according to the spatial status of the device. For example, the operation being performed when the spatial status indicates that the device is deviated from the original position can be different from the operation being performed when the spatial status indicates that the device is not deviated from the original position.

In some embodiments, the operation being performed according to the spatial status may include presenting, on a graphical user interface, information related to the spatial status. For example, if the device is not deviated from the original position, the graphical user interface may display an icon indicating normal status or display any suitable content, such as showing positioning and mapping data. If the device is deviated from the original position, the graphical user interface may prompt a warning message to remind the user to check on the device. In some embodiments, manual adjustment instructions may be presented on the graphical user interface based on the tilt angle, the displacement, and/or the acceleration. For example, the manual adjustment instructions may inform the user details of the spatial status of the device, such as degrees and direction of the tilt and/or displacement offset and direction from the original position, so that the user can adjust the device in an opposite direction manually based on the instructions. If the device is determined to be deviated from the original position due to the acceleration being greater than the acceleration threshold, the adjustment instruction may inform the user to reinforce fixation structure of the device or hold the device steadily to prevent undesirable sways. The graphical user interface may be displayed on a display coupled to the device itself, or a controller, a server and/or another terminal wirelessly connected to the device.

In some embodiments, the operation being performed according to the spatial status may include notifying a remote device about a deviated status of the device in response to determining that the device is deviated from the original position. For example, the spatial status of the device may be sent to the remote device at a predetermined frequency (e.g., 1 Hz). The spatial status may be selected from a deviated status indicating that the device is deviated from the original position and a normal status indicating that the device is maintaining at the original position. In one embodiment, only a binary value indicating the deviated status or the normal status may be sent to the remote device. In another embodiment, additional information of the spatial status may also be sent to the remote device, such as tilted angle, displacement from the original position, etc. In some embodiments, the entity that notifies the remote device may be the same entity that determines the spatial status of the device. The remote device may be the remote device 106 shown in FIG. 1.

In some embodiments, the device having its spatial status monitored may be a GNSS receiver, such as the GNSS receiver 102 in FIG. 1. The GNSS receiver may function as a base station or a mapping device (or rover) in a positioning application scenario (e.g., RTK positioning system). In some embodiments, the GNSS receiver may have three operation modes: mobile base station mode, stationary base station mode, and mapping device mode. When operating in the mobile base station mode or the stationary base station mode, the GNSS receiver may be the source of GNSS differential positioning data and may send the GNSS differential positioning data to a remote device for correcting positioning information (e.g., in real-time). The remote device may be a handheld mapping device, a UAV, or a server. The GNSS receiver may establish wireless connection with the remote device, and use the same connection to transmit the differential positioning data and the spatial status. When operating in the mapping device mode, the GNSS receiver may be configured to receive differential positioning data from a remote device and use the differential positioning data to produce corrected positioning information of one or more to-be-mapped location points. The remote device may be a base station or a positioning service server. Further, the GNSS receiver may receive spatial status of the base station and determine whether to use the differential positioning data from the base station based on whether the spatial status indicates the base station is upright and stable.

In some embodiments, when the device is a GNSS receiver operating in a base station mode, the operation being performed according to the spatial status may include generating updated differential positioning data. For example, it can be determined, based on the pose information, whether the GNSS receiver is in a static state (e.g., according to the acceleration information). When the GNSS receiver is in static state and is deviated from the original position, a tilt angle between a current reference axis of the device and an original reference axis of the device may be obtained, and/or a displacement between a current location of the device and an original location of the device may be obtained. The differential positioning data can be updated based on at least one of the tilt angle or the displacement. As the GNSS receiver is deviated from the original position, the original reference position (e.g., true known location) set for the GNSS receiver is no longer accurate and may be adjusted for the current situation to obtain an updated reference position. The updated reference position may replace the original reference position in generating the differential positioning data until the GNSS receiver is moved back to its original position (e.g., by a maintenance staff and/or indicated by the spatial status). That is, the GNSS receiver may generate real-time positioning data (e.g., satellite position) based on received GNSS signals, and generate the differential positioning data based on a difference between the real-time positioning data and the updated reference position. The updated differential positioning data generated according to the updated reference position may be directly used by a mapping device or a CORS server in providing positioning information.

For example, the GNSS receiver is tilted by an angle of a degrees, the horizontal location of the to-be-corrected position (e.g., the reference position) may be adjusted by an amount of L*sin(a), where L is a length of the GNSS receiver. The direction of the horizontal location adjustment may be the opposite of the tilted direction. A vertical location of the to-be-corrected position may be decreased by L*(1−cos(a)). In another example, the GNSS receiver is moved for a distance. The horizontal location of the to-be-corrected position should be adjusted to compensate the displacement between the original location and the current location at an opposite direction. In another example, when the GNSS receiver is moved and tilted, the adjustment of the to-be-corrected position may be a combination (e.g., a vector sum) of the above-described two types of adjustments. In some embodiments, the GNSS receiver may determine the updated reference position by itself. The GNSS receiver may further notify a remote device (e.g., CORS server) about the updated reference position. In some embodiments, the GNSS receiver may send the pose data such as the tilt angle and/or the displacement to a remote device (e.g., a controller, a server, a mapping device), and the remote device may determine the updated reference position and send back to the GNSS receiver to be used in differential positioning data generation. In some embodiments, the original reference position of the GNSS receiver may not be updated. The mapping device or the CORS server may directly adjust the received differential positioning data using the tilt angle and/or the displacement.

In some embodiments, the device is a GNSS receiver operating in a mapping device mode. The device may acquire first positioning data corresponding to a location point based on GNSS signals received by the device when the device is at the location point. The operation being performed according to the spatial status may include generating positioning information of the location point according to the first positioning data, the differential positioning data, and the spatial status of the device. If the spatial status indicates that the device is not deviated from the original position, the positioning information of the location point can be generated by integrating the first positioning data and the differential positioning data (e.g., using the differential positioning data to correct the first positioning data). If the spatial status indicates that the device is deviated from the original position, the positioning information of the location point generated by the device may be invalid or not accurate. The device may resume generating positioning information when the spatial status indicates that the device is back at the original position. In some embodiments, if the spatial status indicates that the device is deviated from the original position, the device may automatically correct the first positioning data (i.e., the location of location point generated based on signals received from navigational satellites) based on the pose data (e.g., tilted angle, displacement, etc.). For example, the spatial status may indicate that the GNSS receiver is tilted by an angle of a degrees, the horizontal location of the to-be-corrected position (e.g., the first positioning data) may be adjusted by an amount of L*sin(a), where L is a length of the GNSS receiver. The direction of the horizontal location adjustment may be the opposite of the tilted direction. A vertical location of the to-be-corrected position may be decreased by L*(1−cos(a)). Having the deviation being compensated, the corrected first positioning data can be used to generate the positioning information of the location point. In some embodiments, the device operating in a mapping device mode may also receive a status of the base station indicating whether the base station is upright and stable. If the status of the base station indicates that the base station is upright and stable, the device may generate the positioning information of the location point based on the first positioning data corresponding to the location point and the differential positioning data. If the status of the base station indicates that the base station is sloping or unstable, the device may generate the positioning information of the location point based on the first positioning data corresponding to the location point without considering the differential positioning data.

Referring back to FIG. 3, in some embodiments, the terminal 300 may be a controller. The controller may be connected to one or more GNSS receivers (e.g., device 400). The at least one processor 304 of the controller may be configured to obtain a spatial status of a GNSS receiver, the spatial status indicating whether the GNSS receiver is deviated from an original position; and perform an operation according to the spatial status. The at least one processor 304 of the controller may be configured to directly receive the spatial status of a GNSS receiver, or receive sensing data of GNSS receiver and determine locally the spatial status based on the pose information. The at least one processor 304 of the controller may also be configured to present the spatial status on a graphical user interface, and/or if the GNSS receiver is deviated from the original position, present adjustment instructions based on the spatial status such as a tilt angle, a displacement, and/or acceleration. The communication circuit 306 of the controller may be configured to establish connections with a plurality of GNSS receivers, receive differential positioning data generated by the first GNSS receiver, and send the differential positioning data of the first GNSS receiver to a second GNSS receiver. The first GNSS receiver operates as a base station in a positioning system, and the second GNSS receiver operates as a mapping device in the positioning system. The second GNSS receiver may be a handheld RTK positioning device and/or a UAV supporting RTK positioning. The at least one processor 304 of the controller may be configured to receive and present positioning information of one or more location points from the second GNSS receiver which operates as the mapping device.

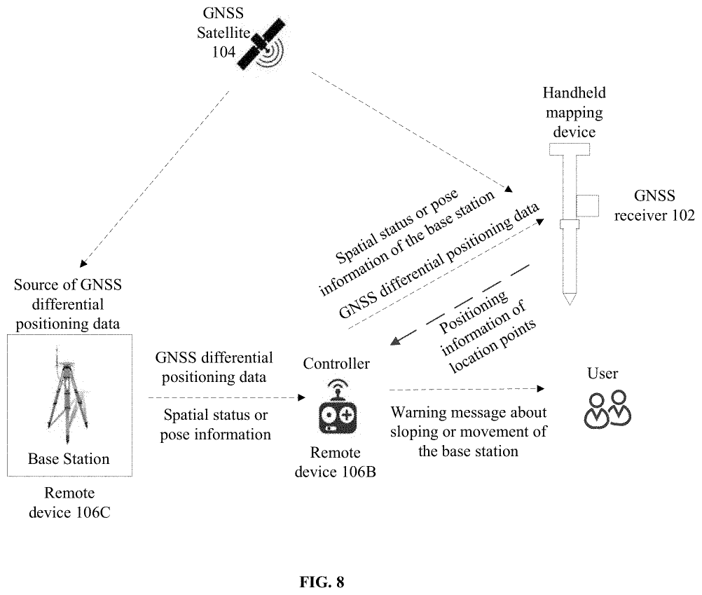

FIGS. 6-10 show positioning schemes using a GNSS receiver in three different operating modes: the mobile base station mode, the mapping device mode, and the stationary base station mode. FIG. 6 is a schematic view showing an application scenario corresponding to the mobile base station mode and data links among multiple entities according to an exemplary embodiment of the present disclosure. As shown in FIG. 6, the application scenario (e.g., a positioning system) includes a navigational satellite (e.g., navigational satellite 104), a base station (e.g., GNSS receiver 102 operating in a mobile base station mode or device 400), a mapping device (e.g., remote device 106A), and a controller (e.g., remote device 106B). The mapping device may be a movable device in the positioning system, such as a UAV, a GNSS receiver carried by a UAV, or a GNSS receiver operating in a handheld mapping device mode. The controller can be, for example, a mobile terminal that runs a controller App. The base station receives signals from the navigational satellite and serves as a source of GNSS differential positioning data. The base station may send the GNSS differential positioning data and spatial status or sensing data of the base station to the controller. The controller may forward the information received from the base station to the mapping device. The differential positioning data sent by the base station is used for correcting positioning data collected by the mapping device. The mapping device (e.g., a UAV or a GNSS receiver operating in a mapping device mode) may generate positioning information of location points according to the differential positioning data and the spatial status of the base station. The mapping device may send the positioning information to the controller. The controller may also present warning message about the base station being deviated from its original position (e.g., tilted or moved) to a user.

In some embodiments, the controller may also present the positioning information of the location points received from the mapping device. In some embodiments, the controller may be a remote control coupled to the UAV, such as a control panel or a smartphone. In some embodiments, the controller may be omitted, and the GNSS differential positioning data and the spatial status or pose data of the base station may be directly sent by the base station to the mapping device. For example, the mapping device may be a GNSS receiver coupled or embedded with a display to show positioning information and warning message. In some embodiments, the base station may determine the spatial status based on the pose information, and send the spatial status to the controller or the mapping device. In some other embodiments, the base station may send the sensing data to the controller and/or the mapping device, and the controller and/or the mapping device can determine the spatial status of the base station according to the pose information.

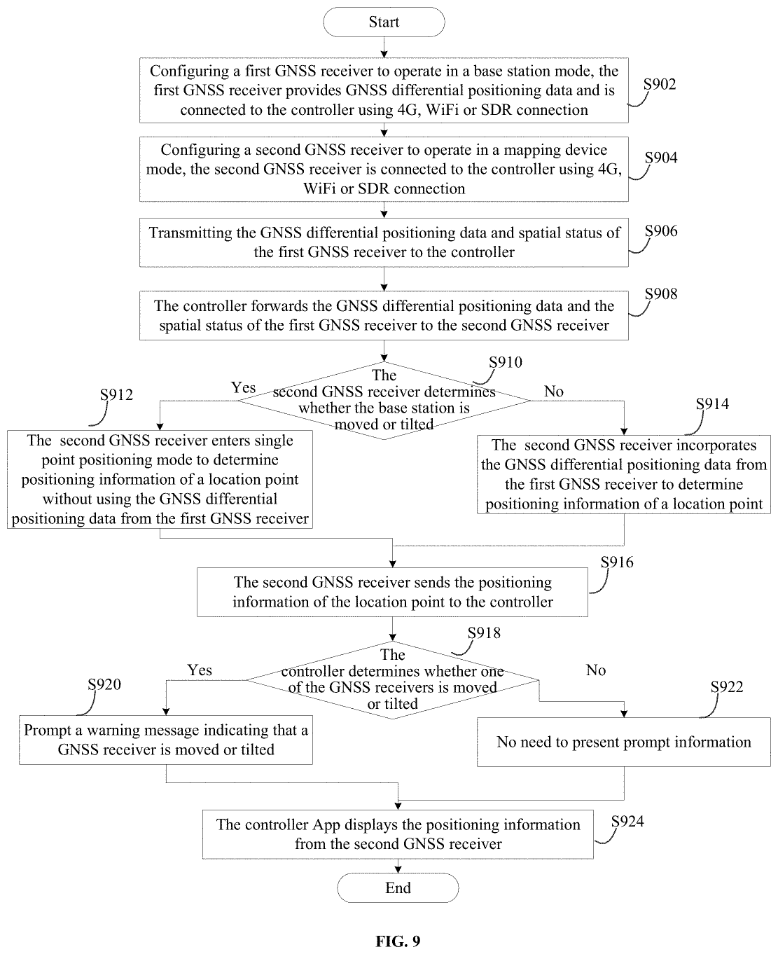

FIG. 7 is a flow chart of a positioning process according to the application scenario shown in FIG. 6. As shown in FIG. 7, at S702, the controller configures the setting of the UAV as RTK positioning. With this setting enabled, the UAV can function as a rover in a positioning system, automatically fly in a field based on a certain path, and record positioning information of location points that the UAV passes. The GNSS receiver (e.g., device 400) can function as a base station. For example, the GNSS receiver may be configured to operate in the mobile base station mode or the stationary base station mode. At S704, the base station is connected to the controller based on any suitable communication protocol, such as 4G, Wi-Fi, or SDR. At S706, as the source of GNSS differential positioning data, the base station transmits the GNSS differential positioning data and the spatial status of the base station to the controller. At S708, the controller may forward the GNSS differential positioning data and the spatial status of the base station to the UAV.

At S710, the UAV determines whether the base station is moved or tilted based on the received spatial status of the base station. At S712, if the base station is moved or tilted (S710: Yes), the UAV enters single point positioning mode to determine positioning information of a location point without using the GNSS differential positioning data from the base station. At S714, if the base station is not moved or tilted (S710: No), the UAV incorporates the GNSS differential positioning data from the base station to determine positioning information of a location point. At S716, the UAV sends the positioning information of the location point to the controller.

At S718, the controller determines whether the base station is moved or tilted based on the received spatial status of the base station. At S720, if the base station is moved or tilted (S718: Yes), the controller prompts a warning message indicating that the base station is moved or tilted. At S722, if the base station is not moved or tilted (S718: No), there is no need to present the warning message. In addition, at S724, the controller displays the positioning information received from the UAV. The order of the processes consistent with the disclosure are not limited to that shown in FIG. 7, but can be any proper order. For example, processes S718 and S710 can be performed in parallel or in any suitable order.

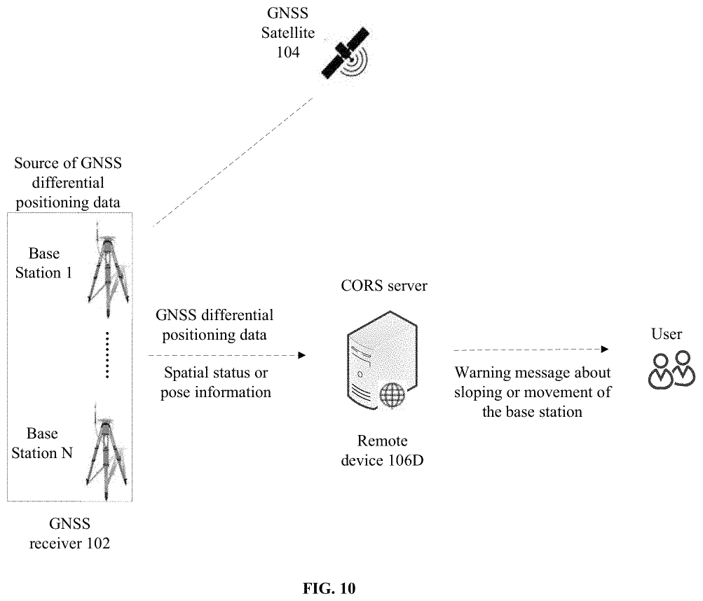

FIG. 8 is a schematic view showing an application scenario corresponding to the mapping device mode according to an exemplary embodiment of the present disclosure. As shown in FIG. 8, the application scenario includes a navigational satellite (e.g., navigational satellite 104), a base station (e.g., remote device 106C which is a GNSS receiver functioning as a base station), a mapping device (e.g., GNSS receiver 102 operating in a mapping device mode), and a controller (e.g., remote device 106B). The controller can be, for example, a mobile terminal that runs a controller App. The mapping device may be a handheld GNSS receiver operating in a mapping device mode. The base station receives signals from the navigational satellite and serves as a source of GNSS differential positioning data. The base station may send the GNSS differential positioning data and spatial status or sensing data of the base station to the controller. The controller may forward the information received from the base station to the mapping device. The mapping device may generate positioning information of location points according to the differential positioning data and the spatial status of the base station. The mapping device may send the positioning information to the controller. The controller may also present warning message about the base station being deviated from its original position (e.g., tilted or moved) to a user. In some embodiment, pose detecting circuits such as IMU are set in both GNSS receiver 102 (mapping device) and remote device 106C (base station). The output of the pose detecting circuits may serve as alarm signals, e.g., informing users the base station is tilted and the pose should be adjusted.

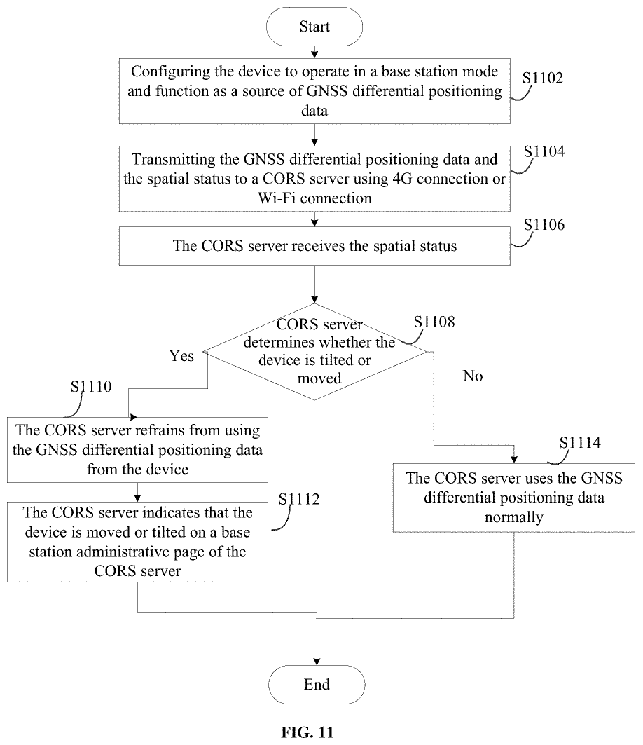

FIG. 9 is a flow chart of a positioning process according to the application scenario shown in FIG. 8. As shown in FIG. 9, at S902, a first GNSS receiver is configured to operate in a base station mode, such as the mobile base station mode or the stationary base station mode. The first GNSS receiver, i.e., the base station, generates GNSS differential positioning data and is connected to the controller based on any suitable communication protocol, such as 4G, Wi-Fi, or SDR. At S704, a second GNSS receiver (e.g., device 400) is configured to operate in a mapping device mode. The second GNSS receiver is connected to the controller based on any suitable communication protocol, such as 4G, Wi-Fi, or SDR. At S906, the first GNSS receiver transmits the GNSS differential positioning data and the spatial status of the first GNSS receiver to the controller. At S908, the controller forwards the GNSS differential positioning data and the spatial status of the first GNSS receiver to the second GNSS receiver.

At S910, the second GNSS receiver determines whether the first GNSS receiver is moved or tilted based on the received spatial status of the first GNSS receiver. At S912, if the first GNSS receiver is moved or tilted (S910: Yes), the second GNSS receiver enters single point positioning mode to determine positioning information of a location point without using the GNSS differential positioning data from the first GNSS receiver, or the second GNSS receiver discards the GNSS differential positioning data and determines a mapping result of the current location point is invalid. At S914, if the first GNSS receiver is not moved or tilted (S910: No), the second GNSS receiver incorporates the GNSS differential positioning data from the first GNSS receiver to determine positioning information of a location point. At S916, the second GNSS receiver sends the positioning information of the location point to the controller. In some embodiments, the second GNSS receiver may include a pose data acquiring circuit and may send its corresponding spatial status or pose information to the controller (e.g., at a predetermined frequency).

At S918, the controller determines whether one of the two GNSS receivers is moved or tilted based on the received corresponding spatial status. At S920, if at least one of the GNSS receivers is moved or tilted (S918: Yes), the controller prompts a warning message identifying the GNSS receiver being moved or tilted. In some embodiments, the controller may discard the positioning information from the second GNSS receiver, provide/present an option of automatically compensating the positioning information based on the tilted angle or displacement of the GNSS receiver being moved or tilted, or present manual adjustment instructions for the GNSS receiver being moved or tilted. At S922, if neither of the GNSS receivers is moved or tilted (S918: No), there is no need to present the warning message. In addition, at S924, the controller displays the positioning information received from the second GNSS receiver. The order of the processes consistent with the disclosure are not limited to that shown in FIG. 9, but can be any proper order. For example, processes S918 and S910 can be performed in parallel or in any suitable order.

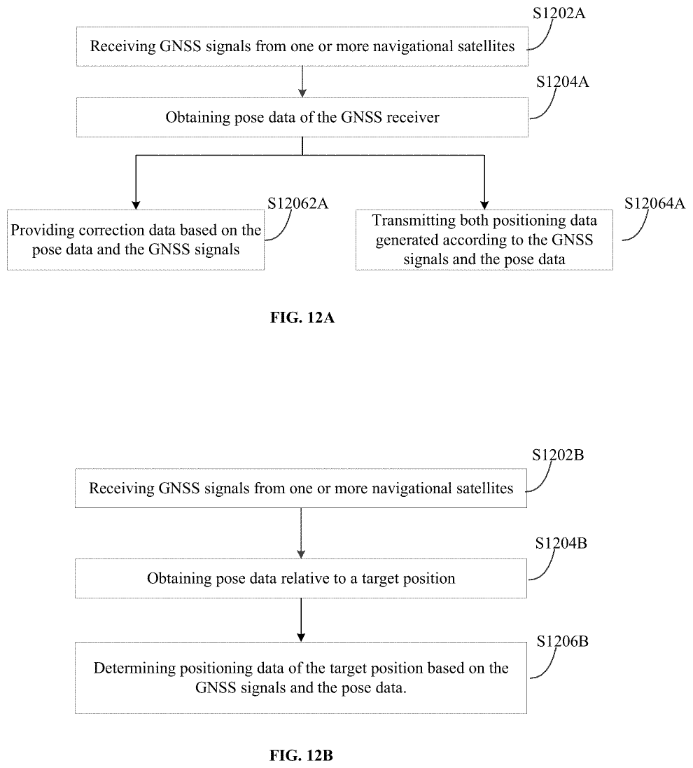

FIG. 10 is a schematic showing an application scenario corresponding to the stationary base station mode according to an exemplary embodiment of the present disclosure. As shown in FIG. 10, the application scenario includes a navigational satellite (e.g., navigational satellite 104), a plurality of base stations (e.g., GNSS receivers 102 operating in the stationary base station mode), and a Continuously Operating Reference Station (CORS) server (e.g., remote device 106D). The base station receives signals from the navigational satellite and serves as a source of GNSS differential positioning data. The base stations may be placed at a plurality of locations and covers different area ranges. The base stations respectively produce and send its corresponding GNSS differential positioning data and its own spatial status or pose information to the CORS server. The CORS server may present warning message identifying a base station being deviated from its original position (e.g., tilted or moved) to a user.

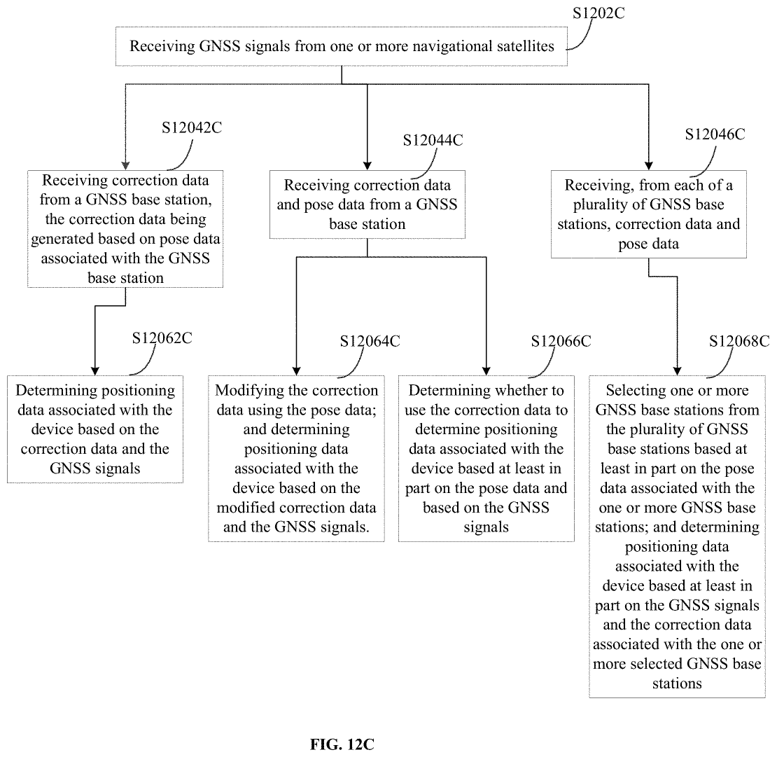

FIG. 11 is a flow chart of a positioning process according to the application scenario shown in FIG. 10. As shown in FIG. 11, at 51102, each of the GNSS receiver is configured to operate in a base station mode (e.g., the stationary base station mode) and function as a source of GNSS differential positioning data. At S1104, each GNSS receiver transmits corresponding GNSS differential positioning data and spatial status to the CORS server using 4G connection or Wi-Fi connection. In some embodiments, the spatial status and/or pose information of a GNSS receiver may be pushed to the CORS server at predetermined frequency (e.g., 1 Hz). The spatial status may include at least one of a flag indicating whether the GNSS receiver is static, a flag indicating whether the GNSS receiver is tilted, pitch angle of the GNSS receiver, roll angle of the GNSS receiver, or heading/yaw angle of the GNSS receiver, etc. At S1106, the CORS server receives the GNSS differential positioning data and the spatial status of the plurality of GNSS receivers.

At S1108, the CORS server determines whether one of the GNSS receivers is moved or tilted based on the received corresponding spatial status. At S1110, if one GNSS receiver is moved or tilted (S1108: Yes), the CORS server refrains from using (e.g., discards) the GNSS differential positioning data from the moved or tilted GNSS receiver. At S1112, the CORS server indicates that the GNSS receiver is moved or tilted on a base station administrative page (e.g., a web terminal/portal hosted by the CORS server). At S1114, if the GNSS receiver is not moved or tilted (S1108: No), the CORS server uses the GNSS differential positioning data normally to provide positioning or navigation services. For example, a mapping device (e.g., a GNSS receiver functioning in a mapping device mode or a UAV) may communicate with the CORS server to obtain GNSS differential data of one or more base stations located within a certain distance range of the mapping device.

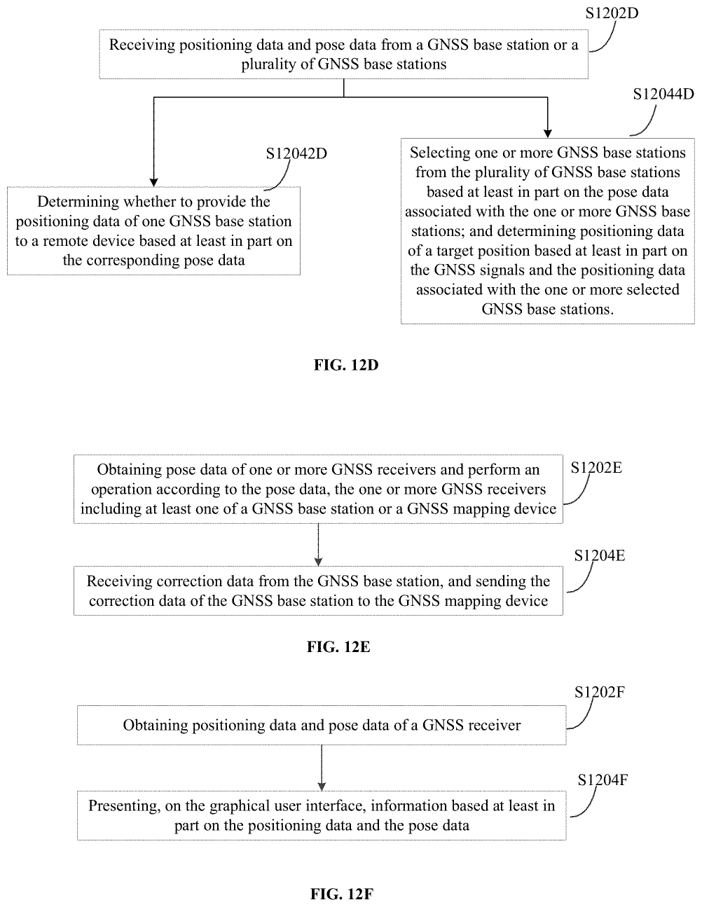

FIGS. 12A-12F are each a flow chart of a process according to an exemplary embodiment of the present disclosure. The entity that implements the shown process may be the terminal 300 and/or the device 400. In some embodiments, the entity may also implement disclosed embodiments consistent with FIGS. 5-11.

FIG. 12A illustrates a process implemented by a GNSS base station consistent with some disclosed embodiments. As shown in FIG. 12A, at S1202A, the GNSS base station receives one or more Global Navigation Satellite System (GNSS) signals from one or more navigational satellites. The GNSS base station is at least one of a permanent GNSS base station, a temporary GNSS base station, or a handheld GNSS base station. The GNSS base station may calculate positioning data of itself based at least in part on the GNSS signals. The positioning data may be correction data (e.g., differential positioning data), and/or measured positioning data.

At S1204A, the GNSS base station obtains or determines pose data of the GNSS base station (e.g., GNSS receiver of the GNSS base station configured to receive the GNSS signals). For example, the pose data can be determined based on sensing data collected by a pose sensor. The pose sensor includes at least one of an inertial measurement unit, a gyroscope, an accelerometer, a magnetometer, a vision sensor, or proximity sensor. In some embodiments, the pose sensor is co-located with a GNSS signal reception circuit (also called GNSS receiver) of the GNSS base station.

The pose data indicates whether the GNSS base station deviates from a predetermined pose. The predetermine pose or the actual pose of the GNSS base station may include position coordinates such as (x, y, z) and/or attitude information such as rotation with respect to coordinate axes. Determining the pose data includes determining at least one of: a tilt status based on whether a tilt angle (e.g., angle displacement measured by degree unit) between a current reference axis of the GNSS base station and a predetermined reference axis of the GNSS base station is greater than an angle threshold; a displacement status based on whether a displacement (e.g., vector displacement measured by length unit) between a current location of the GNSS receiver and a predetermined location of the GNSS base station is greater than a distance threshold; or an acceleration status based on whether an acceleration of the GNSS base station within a time period is greater than an acceleration threshold. When determining at least one of: the tilt angle being greater than the angle threshold, the displacement being greater than the distance threshold, or the acceleration being greater than the acceleration threshold, the pose data can be generated to indicate that the GNSS base station deviates from the predetermined pose. In some embodiments, the pose data may be an indicator that suggests there is a deviation, the actual pose, and/or relative displacement from the predetermined pose. The pose data may include an absolute value associated with the deviation, a relative value associated with the deviation, and/or a vector indicating both amplitude and direction of the deviation.

In some embodiments, at S12062A, the GNSS base station provides correction data based on the GNSS signals and the pose data. In one example, the GNSS base station determines a measured position of the GNSS receiver based on the GNSS signals; updates a reference position of the GNSS receiver based on the pose data to obtain an updated reference position; and determines the correction data based on the measured position and the updated reference position. In another example, the GNSS base station determines a measured position of the GNSS receiver based on the GNSS signals; updates the measured position of the GNSS receiver based on the pose data to obtain an updated measured position; and determines the correction data based on the updated measured position and the reference position.

In some embodiments, the GNSS base station obtains, according to the pose data, at least one of an angle displacement between a current reference axis of the GNSS receiver and a predetermined reference axis of the GNSS receiver, or a vector displacement between a current location of the GNSS receiver and a predetermined location of the GNSS receiver. The reference position of the GNSS base station or the measured position of the GNSS base station may be updated based on at least one of the angle displacement or the vector displacement.

In some embodiments, the GNSS base station transmits the correction data to a remote device. In some embodiments, the GNSS base station also transmit part or all of the pose data to the remote device.

In some embodiments, at S12064A, the GNSS base station transmits both the positioning data and the pose data to a remote device. The positioning data may or may not be corrected or calibrated based on the pose data.

The remote device is a remote controller, an autonomous vehicle, an unmanned aerial vehicle (UAV), a GNSS receiver operating in a mapping device mode, and/or a Continuously Operating Reference Station (CORS) server.

FIG. 12B illustrates a process implemented by a mapping device consistent with some disclosed embodiments. As shown in FIG. 12B, at S1202B, the mapping device receives GNSS signals from one or more navigational satellites (e.g., by a GNSS receiver of the mapping device). The mapping device may be an autonomous vehicle, an unmanned aerial vehicle (UAV) and/or a GNSS receiver operating in a mapping device mode (i.e., rover mode).

At S1204B, the mapping device measures pose data of the GNSS receiver relative to a target position. The target position is a position for which the device/user intends to obtain the GNSS location. In some embodiments, a positional relationship between the target position and the GNSS receiver can be obtained. In one example, the target position is a position where a bottom of the device is located; the GNSS receiver is located at a top of the device; and the positional relationship is indicated by a preset vector describing a displacement between the target position and the GNSS receiver, e.g., the preset vector may include a vertical displacement. In another example, the GNSS receiver and the target position are at the same place, and the preset vector is 0. In some embodiments, the pose data is measured by a pose sensor. For example, the pose sensor is co-located with the GNSS receiver or the target position. The pose sensor includes at least one of an inertial measurement unit, a gyroscope, an accelerometer, a magnetometer, a vision sensor, or proximity sensor.

The pose data of the GNSS receiver indicates whether the GNSS receiver of the mapping device deviates from a predetermined pose. The pose data may also include an angular displacement from the predetermined pose and/or a vector displacement from the predetermined pose. Determining the pose data includes determining at least one of: a tilt status based on whether a tilt angle (e.g., angle displacement) between a current reference axis of the GNSS receiver/the mapping device and a predetermined reference axis of the GNSS receiver is greater than an angle threshold; a displacement status based on whether a displacement (e.g., vector displacement) between a current location of the GNSS receiver and a predetermined location of the GNSS receiver is greater than a distance threshold; or an acceleration status based on whether an acceleration of the GNSS receiver within a time period is greater than an acceleration threshold. When determining at least one of: the tilt angle being greater than the angle threshold, the displacement being greater than the distance threshold, or the acceleration being greater than the acceleration threshold, the pose data can be generated to indicate that the mapping device deviates from the predetermined pose.

At S1206B, the mapping device determines positioning data of the target position based on the GNSS signals and the pose data. In some embodiments, the mapping device determines a measured position of the GNSS receiver based on the GNSS signals received from the one or more navigational satellites; and determines the target position based on the measured position of the GNSS receiver, the positional relationship between the GNSS receiver and the target position, and the pose data of the GNSS receiver.

In some embodiments, when the pose data indicates that the GNSS receiver does not deviate from the predetermined pose, determining the target position based on the measured position of the GNSS receiver and the positional relationship between the GNSS receiver and the target position. In some other embodiments, when the pose data indicates that the GNSS receiver deviates from the predetermined pose, the mapping device updates the measured position of the GNSS receiver based on the pose data to obtain an updated measured position; and determines the target position based on the updated measured position of the GNSS receiver and the positional relationship between the GNSS receiver and the target position. In some other embodiments, when the pose data indicates that the GNSS receiver deviates from the predetermined pose, the mapping device updates the positional relationship between the GNSS receiver and the target position based on the pose data to obtain an updated positional relationship; and determines the target position based on the measured position of the GNSS receiver and the updated positional relationship between the GNSS receiver and the target position.

In some embodiments, the mapping device may receive correction data from a GNSS base station directly or indirectly through a controller. The target position can be determined based on the measured position of the GNSS receiver, the positional relationship between the GNSS receiver and the target position, the pose data of the GNSS receiver, and the correction data. In some embodiments, the correction data is generated based on pose data associated with the GNSS base station. For example, the pose data associated with the GNSS base station is generated by the GNSS base station based on sensing data from one or more pose sensors of the GNSS base station. The mapping device may determine whether to use the correction data for determining the target position based on the pose data associated with the GNSS base station. A message about the pose data of the mapping device and/or the pose data of the GNSS base station may also be presented on a graphical user interface.

FIG. 12C illustrates a process implemented by a receiver device consistent with some disclosed embodiments. As shown in FIG. 12C, at S1202C, the device receives GNSS signals from one or more navigational satellites.

In some embodiments, at S12042C, the device receives correction data from a GNSS base station. The correction data is generated based on pose data associated with the GNSS base station. In some other embodiments, at S12044C, the device may receive both correction data and pose data from the GNSS base station. In some other embodiments, at S12046C, the device may receive correction data and pose data from a plurality of GNSS base stations.

The pose data associated with a GNSS base station indicates whether the GNSS base station deviates from a predetermined pose. The pose data is generated by the GNSS base station based on sensing data from one or more pose sensors of the GNSS base station. In some embodiments, the pose data of the GNSS base station includes at least one of an angular displacement from the predetermined pose or a vector displacement from the predetermined pose

In some embodiments, at S12062C, the device determines positioning data associated with the device based on the correction data and the GNSS signals. In some embodiments, the device determines whether to use the correction data for determining the positioning data based on the pose data. For example, the device may use the correction data and the GNSS signals for determining the positioning data when the pose data indicates that the GNSS base station does not deviate from the predetermined pose. The device may use the GNSS signals for determining the positioning data without using the correction data when the pose data indicates that the GNSS base station deviates from the predetermined pose.

In some embodiments, at S12064C, the device modifies the correction data using the pose data, and determines positioning data associated with the device based on the modified correction data and the GNSS signals. For example, the correction data may be modified based on at least one of the angular displacement or the vector displacement to compensate the deviation of the GNSS base station from the predetermined pose.

In some embodiments, at S12066C, the device determines whether to use the correction data to determine positioning data associated with the device based at least in part on the pose data and based on the GNSS signals. For example, the device may compare the deviation from the GNSS base station with a deviation threshold, such as comparing the angular displacement with an angular threshold and/or comparing the vector displacement with a displacement threshold. The device may use the correction data and the GNSS signals to determine the positioning data associated with the device based on the pose data when the deviation is not greater than the deviation threshold. Alternatively, the device may use the GNSS signals to determine the positioning data associated with the device without using the correction data when the deviation is greater than the deviation threshold.

In some embodiments, at S12068C, the device may select one or more GNSS base stations from the plurality of GNSS base stations based at least in part on the pose data associated with the one or more GNSS base stations; and determine positioning data associated with the device based at least in part on the GNSS signals and the correction data associated with the one or more selected GNSS base stations. For example, for each of the plurality of GNSS base stations, the device may compare the corresponding pose data with a deviation threshold, such as comparing the angular displacement with an angular threshold and/or comparing the vector displacement with a displacement threshold. The device selects the GNSS base station if the corresponding pose data does not exceed the deviation threshold. In some embodiments, the device modifies, for each of the selected one or more GNSS base stations, the corresponding correction data based on the corresponding pose data to obtain an updated correction data; and determines the positioning data associated with the device based on the GNSS signals and the updated correction data associated with the one or more selected GNSS base stations.

In some embodiments, the device assigns, for each of the one or more selected GNSS base stations, a weight for the corresponding correction data of the GNSS base station; and determine the positioning data associated with the device based on the GNSS signals, and the correction data and the corresponding weight of each of the one or more selected GNSS base stations. For example, the weight for the corresponding correction data of the GNSS base station based on: a distance between the GNSS base station and the device.

FIG. 12D illustrates a process implemented by a server consistent with some disclosed embodiments. As shown in FIG. 12D, at S1202D, the server receives positioning data and pose data from a GNSS base station or a plurality of GNSS base stations. The pose data indicates whether the GNSS base station deviates from a predetermined pose. The pose data associated with the GNSS base station is generated by the GNSS base station based on sensing data from one or more pose sensors of the GNSS base station In some embodiments, the positioning data includes a measured position of the GNSS base station generated based on GNSS signals received by the GNSS base station, a reference position of the GNSS base station, and/or correction data generated by the GNSS base station based on the measured position and the predetermined reference position. In some embodiments, the positioning data may include an identification of the GNSS base station. The reference position of GNSS base station may be prestored in a memory based on the identification of the GNSS base station.

In some embodiments, at S12042D, the server determines whether to provide the positioning data to a remote device based at least in part on the pose data. The positioning data may be provided by the server in response to a request from the remote device. The request may be a navigational service request, a positioning service request, a mapping service request, and/or a base station administration request. In one example, the server may determine to provide the positioning data to the remote device when the pose data indicates that the GNSS base station does not deviate from the predetermined pose; and determine not to provide the positioning data to the remote device when the pose data indicates that the GNSS base station deviates from the predetermined pose. In another example, the server may compare the deviation of the GNSS base station with a deviation threshold, such as comparing the angular displacement with an angular threshold or comparing the vector displacement with a displacement threshold. The server may determine to provide the positioning data to the remote device when the deviation is not greater than the deviation threshold; and determine not to provide the positioning data to the remote device when the deviation is greater than the deviation threshold. Further, the server may modify the positioning data from the GNSS base station using the pose data when the deviation is not greater than the deviation threshold; and provide the modified positioning data to the remote device. In some embodiments, the server may modify the reference position of the GNSS base station using the pose data; and send the modified reference position to the GNSS base station to be used by the GNSS base station in generating subsequent correction data. In some embodiments, a message about the pose data, the positioning data, and/or the modified positioning data may be presented on a graphical user interface associated with the server.

In some embodiments, at S12044D, the server may select one or more GNSS base stations from the plurality of GNSS base stations based at least in part on the pose data associated with the one or more GNSS base stations; and determine positioning data of a target position based at least in part on the GNSS signals and the positioning data associated with the one or more selected GNSS base stations. In some embodiments, the pose data associated with each of the selected GNSS base station indicates that the corresponding GNSS base station does not deviate from the predetermined pose or the deviation does not exceed a deviation threshold. For example, the server may compare, for each GNSS base station, the corresponding pose data with a deviation threshold; and select the GNSS base station if the corresponding pose data does not exceed the deviation threshold. In some embodiments, the server modifies, for each of the selected one or more GNSS base stations, the corresponding positioning data based on the corresponding pose data to obtain modified positioning data; and determines the positioning data of the target location based on the modified positioning data associated with the one or more selected GNSS base stations.

In some embodiments, the server may assign, for each of the one or more selected GNSS base stations, a weight for the corresponding positioning data of the GNSS base station; and determine the positioning data of the target location based on the corresponding positioning data and the corresponding weight of each of the one or more selected GNSS base stations. The weight may be assigned based on: a distance between the GNSS base station and the target location. In some other embodiments, the server may assign, for each of the plurality of GNSS base stations, a weight for the corresponding positioning data of the GNSS base station based on the corresponding pose data of the GNSS base station. The weight for a non-selected GNSS base station is 0, and the weight for each of the one or more selected GNSS stations is greater than 0. For example, each selected GNSS station has a weight 1, a weight corresponding to a distance from the target location, a weight corresponding to the deviation from the predetermined pose, or a weight reflecting the combination of the distance from the target location and the deviation from the predetermined pose. The server may determine the positioning data of the target location based on the corresponding positioning data and the corresponding weight of each of the plurality of GNSS base stations, such as using a linear combination.

FIG. 12E illustrates a process implemented by a controller consistent with some disclosed embodiments. As shown in FIG. 12E, at S1202E, the controller obtains pose data of one or more GNSS receivers and perform an operation according to the pose data, the one or more GNSS receivers including at least one of a GNSS base station or a GNSS mapping device. The pose data of each of the one or more GNSS receivers indicates whether the corresponding GNSS receiver is deviated from a predetermined pose. In some embodiments, the control may present on a graphical user interface, a message about the pose data of the one or more GNSS receivers. In some embodiments, the pose data of each of the one or more GNSS receivers includes at least one of an angular displacement from the predetermined pose or a vector displacement from the predetermined pose. In some embodiments, the controller presents on a graphical user interface, manual adjustment instruction based on at least one of the angular displacement or the vector displacement.

At S1204E, the controller receives correction data from the GNSS base station, and sends the correction data of the GNSS base station to the GNSS mapping device. In some embodiments, the controller may modify the correction data received from the GNSS base station based on at least one of the angular displacement or the vector displacement corresponding to the GNSS base station, and send the modified correction data to the GNSS mapping device.

In some embodiments, the controller may receive, from the GNSS mapping device, positioning data of a target location, the position data being generated based on the correction data from the GNSS base station. The controller may also present, on a graphical user interface, the positioning data of the target location. In some embodiments, the controller may receive pose data of the GNSS base station and send the pose data of the GNSS base station to the GNSS mapping device.

FIG. 12F illustrates a process implemented by a device having a graphical user interface consistent with some disclosed embodiments. As shown in FIG. 12F, at S1202F, the device obtains positioning data and pose data of a GNSS receiver. The pose data is generated by the GNSS receiver based on sensing data from one or more pose sensors of the GNSS receiver. The pose data indicates whether the GNSS receiver is deviated from a predetermined pose. In some embodiments, the GNSS receiver is a GNSS base station. The positioning data may include a reference position of the GNSS base station, a measured position of the GNSS base station generated from GNSS signals received by the GNSS base station, and/or a correction data generated by the GNSS base station based on the measured position and the reference position. In some embodiments, the GNSS receiver is a GNSS mapping device. The positioning data may include a measured position of the GNSS mapping device generated from GNSS signals received by the GNSS mapping device; and/or positioning data of a target location generated by the GNSS mapping device based on the measured position and correction data from a GNSS base station.

At S1204F, the device presents on a graphical user interface of the device, information based at least in part on the positioning data and the pose data. For example, the device may present a warning message when the pose data indicates that the GNSS receiver is deviated from the predetermined pose. The device may present an identification of the GNSS receiver to indicate which GNSS receiver, among multiple GNSS receivers, needs to be adjusted. The device may present manual adjustment instruction based on at least one of the angular displacement or the vector displacement.

The present disclosure provides a method and device that increases accuracy and reliability of the device using pose information. The device can be a GNSS receiver or RTK positioning device capable of operating under different modes and application scenarios with high precision and reliability. Real-time pose information can be obtained from one or more sensors, and a user can be informed on the spatial status using various interaction schemes, which greatly improves user experience. In system design aspect, IMU may be, e.g., integrated with RTK positioning device (e.g., GNSS receiver). The high-frequency data output (2000 Hz) of the IMU may be used to obtain pose information of the device, implement static status detection algorithm and tilt detection algorithm. Suitable threshold may be set. The spatial status including a static detection flag and a tilt detection flag may be obtained based on the pose information and the threshold. In interaction design aspect, user interactions in different operating modes are fully integrated in the positioning process. In the mobile base station mode and the handheld mode (i.e., mapping device mode), the device may push the static detection flag and/or the tilt detection flag in real time through the SDR wireless link to be displayed in a remote control App to a user. In the CORS station mode (i.e., stationary base station mode), the flag(s) can be reported to the background management server via 4G network or Ethernet, and the spatial status of each RTK device (CORS base station) can be recorded in real time. Such design ensures the reliability and high maintainability of the device. When the device is tilted for a considerable angle, when the device is moved, or when accuracy of the positioning data provided by the device is impaired due to other environmental or unexpected factors, such situations can be timely reported to the user, and timely maintenance and repair can be performed.

In the conventional technologies, base stations are disposed outside. The occurrence of tilting or movement cannot be detected in time and can only be manually spotted based on a maintenance schedule. There is no quantitative standard for determining occurrence of tilting or movement. A staff can only qualitatively determine whether the installation scenario of the base station meets the requirements for use. Further, no instruction is given to a user when the user is operating a rover. It is likely that a newcomer may not operate according to the specification of use. However, no interaction is available for the user to correct operation errors, affecting the accuracy. Moreover, timeliness of inspection is poor. Since the inspection is performed manually from time to time, it is difficult to detect problems in time.

Comparing to the conventional technologies, the disclosed device/system and method have the following advantages. For example, a user can obtain the spatial status of the device in real time by monitoring through a web portal of a remote server or through the App installed on a mobile terminal. If the device is deviated from the original position by a great amount, the user can go to the site to maintain the device in time, which improves usage reliability. Further, suitable thresholds (e.g., angle threshold, acceleration threshold, distance threshold) can be set based on the environment of the device. When one or more threshold is exceeded, a corresponding flag (e.g., static flag and/or tilt flag of the spatial status) can be raised and pushed to an external device. Compared to manual qualitative detection, such quantitative detection can improve the reliability of the device. In addition, the device supports interfacing with other entities under different operation modes. The flag can be pushed to a web terminal of a background supervision server through 4G network or Ethernet, or pushed to an App interface of another device that has been frequency-matched through SDR wireless link. When the flag is enabled, warning information is prompted on the corresponding user interaction interface to correct the user's usage in time. Moreover, when the device is in normal use state, the flag and/or the warning information of the current device are provided to the interactive terminal at a frequency of 1 Hz to prevent the accuracy from being affected due to tilting or movement

The processes shown in the figures associated with the method embodiments can be executed or performed in any suitable order or sequence, which is not limited to the order and sequence shown in the figures and described above. For example, two consecutive processes may be executed substantially simultaneously where appropriate or in parallel to reduce latency and processing time, or be executed in an order reversed to that shown in the figures, depending on the functionality involved.

Further, the components in the figures associated with the device embodiments can be coupled in a manner different from that shown in the figures as needed. Some components may be omitted and additional components may be added.

Other embodiments of the disclosure will be apparent to those skilled in the art from consideration of the specification and practice of the embodiments disclosed herein. It is intended that the specification and examples be considered as exemplary only and not to limit the scope of the disclosure, with a true scope and spirit of the invention being indicated by the following claims.

What is claimed is:

1. A device, comprising:
a Global Navigation Satellite System (GNSS) receiver configured to receive GNSS signals from one or more navigational satellites;
a pose sensor configured to measure pose data of the GNSS receiver; and
one or more processors configured to provide correction data based on the GNSS signals and the pose data.

2. The device of claim 1, wherein:
the device is at least one of a permanent GNSS base station, a temporary GNSS base station, or a handheld GNSS base station.

3. The device of claim 2, wherein:
the GNSS receiver and the one or more processors are configured to support Real-Time Kinematic (RTK) positioning.

4. The device of claim 1, wherein:
the pose sensor is co-located with the GNSS receiver.

5. The device of claim 1, wherein:
the pose data indicates whether the GNSS receiver deviates from a predetermined pose.

6. The device of claim 5, wherein the pose sensor is further configured to determine at least one of:
a tilt status based on whether a tilt angle between a current reference axis of the GNSS receiver and a predetermined reference axis of the GNSS receiver is greater than an angle threshold;
a displacement status based on whether a displacement between a current location of the GNSS receiver and a predetermined location of the GNSS receiver is greater than a distance threshold; or
an acceleration status based on whether an acceleration of the GNSS receiver within a time period is greater than an acceleration threshold.

7. The device of claim 6, wherein the pose sensor is further configured to:
generate the pose data indicating that the GNSS receiver deviates from the predetermined pose when determining at least one of: the tilt angle being greater than the angle threshold, the displacement being greater than the distance threshold, or the acceleration being greater than the acceleration threshold.

8. The device of claim 5, wherein the pose data comprises at least one of an angular displacement from the predetermined pose or a vector displacement from the predetermined pose.

9. The device of claim 5, wherein the one or more processors are further configured to present, on a graphical user interface, a message about the pose data.

10. The device of claim 1, wherein the one or more processors are further configured to:
determine a measured position of the GNSS receiver based on the GNSS signals;
update a reference position of the GNSS receiver based on the pose data to obtain an updated reference position; and
determine the correction data based on the measured position and the updated reference position.

11. The device of claim 10, wherein the one or more processors are further configured to:
obtain, according to the pose data, at least one of an angle displacement between a current reference axis of the GNSS receiver and a predetermined reference axis of the GNSS receiver, or a vector displacement between a current location of the GNSS receiver and a predetermined location of the GNSS receiver; and
update the reference position of the GNSS receiver based on at least one of the angle displacement or the vector displacement to obtain the updated reference position.

12. The device of claim 1, wherein the one or more processors are further configured to:
determine a measured position of the GNSS receiver based on the GNSS signals;
update the measured position of the GNSS receiver based on the pose data to obtain an updated measured position; and
determine the correction data based on the updated measured position and a reference position of the GNSS receiver.

13. The device of claim 12, wherein the one or more processors are further configured to:
obtain, according to the pose data, at least one of an angle displacement between a current reference axis of the GNSS receiver and a predetermined reference axis of the GNSS receiver, or a vector displacement between a current location of the GNSS receiver and a predetermined location of the GNSS receiver; and
update the measured position of the GNSS receiver based on at least one of the angle displacement or the vector displacement to obtain the updated measured position.

14. The device of claim 1, further comprising:
a communication circuit configured to transmit to a remote device at least one of:
the correction data, or
part or all of the pose data.

15. The device of claim 1, wherein:
the pose sensor comprises at least one of an inertial measurement unit, a gyroscope, an accelerometer, a magnetometer, a vision sensor, or proximity sensor.

16. A device, comprising:
a Global Navigation Satellite System (GNSS) receiver configured to receive GNSS signals from one or more navigational satellites;
a communication circuit configured to receive correction data from a GNSS base station, wherein the correction data is generated based on pose data associated with the GNSS base station; and
one or more processors configured to determine positioning data associated with the device based on the correction data and the GNSS signals.

17. The device of claim 16, wherein:
the communication circuit is further configured to receive the pose data associated with the GNSS base station; and
the one or more processors are further configured to determine whether to use the correction data for determining the positioning data based on the pose data.

18. The device of claim 17, wherein:
the pose data associated with the GNSS base station indicates whether the GNSS base station deviates from a predetermined pose; and
the one or more processors are further configured to use the correction data and the GNSS signals for determining the positioning data when the pose data indicates that the GNSS base station does not deviate from the predetermined pose; and use the GNSS signals for determining the positioning data without using the correction data when the pose data indicates that the GNSS base station deviates from the predetermined pose.

19. The device of claim 16, wherein the pose data is generated by the GNSS base station based on sensing data from one or more pose sensors of the GNSS base station.

20. A method, comprising:
receiving one or more Global Navigation Satellite System (GNSS) signals by a GNSS base station;
determining, by the GNSS base station, pose data of the GNSS base station; and
providing, by the GNSS base station, correction data based on the GNSS signals and the pose data.
